(19) United States
(12) Patent Application Publication
(10) Pub. No.: US 2023/0267242 A1
(43) Pub. Date: Aug. 24, 2023

(54) METHOD AND SYSTEM THEREOF FOR ESTABLISHING MODEL FOR ASSESSING CONSTRUCTION SITE RISK LEVELS THROUGH DERIVING BIM-BASED HAZARD FACTORS

(71) Applicants: HOSEO University Academic Cooperation Foundation, Asan-si (KR); Samsung Display Co., Ltd., Yongin-si (KR)

(72) Inventors: Joseph AHN, Asan-si (KR); Hui Jea GO, Suwon-si (KR); Ji Hun HYUN, Cheonan-si (KR); Ju Hee LEE, Ansan-si (KR); Hyung Suk WOO, Asan-si (KR); Jae Woong LEE, Hwaseong-si (KR); Soo Young KIM, Asan-si (KR); Eun Seob CHOI, Asan-si (KR); Mi Jin HA, Asan-si (KR)

(21) Appl. No.: 18/152,801

(22) Filed: Jan. 11, 2023

(30) Foreign Application Priority Data
Feb. 22, 2022 (KR) 10-2022-0023069

(51) Int. Cl. G06F 30/13

(52) U.S. Cl. CPC G06F 30/13; G06F 2111/02

(57) ABSTRACT

A method and a system thereof for establishing a model for assessing construction site risk levels through deriving BIM-based hazard factors are proposed. The method includes step S110 of collecting similar study trends, step S120 of analyzing a CSI hazard factor profile database, step S130 of collecting construction company development cases and trends, step S200 of establishing a classification system of a risk assessment DB (110) and including step S210 of systematizing a construction site category, step S220 of deriving a quantitative risk level calculation method, and step S230 of analyzing current risk assessment, step S300 of developing a framework and including step S310 of deriving a construction site hazard factor visualization method and step S320 of developing a risk assessment model framework, step S500 of transmitting BIM-based risk assessment model data, and receiving feedback including supplemented data, and step S600 of establishing the BIM-based risk assessment model.

### CROSS REFERENCE TO RELATED APPLICATION

The present application claims priority to Korean Patent Application No. 10-2022-0023069, filed Feb. 22, 2022, the entire contents of which is incorporated herein for all purposes by this reference.

### BACKGROUND OF THE INVENTION

### Field of the Invention

The present disclosure relates to a method for establishing a construction site risk level assessment model and, more particularly, to a method and a system thereof for establishing a model for assessing construction site risk levels through deriving BIM-based hazard factors, wherein Building Information Modeling (BIM) is used in the field of risk assessment, so as to quantitatively derive hazard factors, whereby risks may be identified early and eliminated in advance.

### Description of the Related Art

In the construction industry, serious accidents frequently occur due to problems such as a changeable yet poor work environment according to complex production structures and on-site production, and management difficulties caused by subcontracting. As of year 2020, in South Korea, the domestic construction industry's accident rate was 24.7% (i.e., 26,799 workers), the highest among single industries, and the death rate was 27.5% (i.e., 567 workers), the highest among all industries (according to Korea Occupational Safety and Health Agency, Industrial Accident Statistics, Current status of industrial accidents, January, 2020).

The government of South Korea has also recognized such problems, and announced safety reinforcement measures to prevent accidents in the construction industry, and so on, and in order to ensure safety in the construction industry, the government has made various efforts such as reorganization of related laws and systems, establishment of safety awareness through education and publicity, and introduction of smart construction technology. Among those measures, risk assessment is used to obtain fundamental data for assessing hazard factors in a construction stage in advance and establish disaster reduction measures, and thus as the risk assessment proceeds faster and more accurately, effectiveness of construction safety management increases as well.

A conventional risk assessment includes a harmful risk prevention plan at a design stage, D-1 Risk Inspection (DRI) conducted right before on-site works, and the like. However, it is difficult to conduct consistent reviews because subjective assessment is mainly conducted while depending on the knowledge and experience of a safety management worker, and at current domestic construction sites where new technologies and new construction methods are continuously introduced, it is difficult to identify early on hazard factors of the new construction methods for which the safety managers has not directly or indirectly experienced. In particular, in a case of a construction site with a large scale construction, there is a high possibility of human errors regarding accuracy of safety measures, etc., and due to the lack of quantitative data for hazard factor analysis, current risk assessment methods have weak aspects in risk assessment for the new construction methods.

Meanwhile, by applying Building Information Modeling (BIM), whose utilization is increasing recently, to construction safety management, various studies are in progress such that 4D virtual construction simulation is used to obtain safety management data through process visualization, a safety management process applying the BIM is proposed, and a fall accident prevention system based on the BIM has been developed.

However, rather than performing risk assessment, existing studies are limited to modeling and visualizing hazard factors with BIM to support user decision-making or automatic review of safety laws and regulations, etc., and in reality, studies that proceed with the risk assessment itself with the BIM are relatively insufficient.

In order to apply BIM to the field of risk assessment, linkage between BIM attribute information and data for risk assessment, derivation of hazard factors based on the BIM, calculation of quantitative risk levels, and application of reduction measures are required. However, currently, the use of the BIM in the field of safety management is low, and is difficult because accident data is not managed systematically.

In the case of foreign countries, concepts such as OSHA in the US, HSE in the UK, and ConSASS in Singapore are established, and a corresponding assessment plan is established, so as to be applied in an actual construction process, thereby working on on-site safety management. Among the efforts, many studies are in progress in order to apply safety management combined with BIM technology to safety management at construction sites.

Workers at construction sites are exposed to numerous hazard factors. In order to prevent the hazard factors, the government of South Korea currently puts efforts to establish a concept of “Design for Safety” for achieving design in consideration of on-site safety from a design stage, and distribute the design safety review manuals and laws, so as to achieve risk management at the construction sites.

Although current studies in this regard are being actively conducted, it is difficult so far to perform accurate and fast assessment because the amount of information required to be directly applied to on-sites is vast and a consistent review method is absent.

As a related art, Korean Patent No. 10-2004903 is disclosed. The title of the above related art is a “METHOD, APPARATUS AND COMPUTER-READABLE MEDIUM FOR ANALYZING FIRE DANGEROUSNESS OF OLD BUILDING”, and is a technique for assessing fire risk levels through predetermined assessment standards. However, the above related art does not assess a risk level for each object constituting a building or structure, and does not disclose content of determining risks during construction of the building.

### DOCUMENTS OF RELATED ART

### Patent Documents

(Patent Document 1) Korean Patent No. 10-2004903

(Patent Document 2) Korean Patent Application Publication No. 10-2014-0117883

### SUMMARY OF THE INVENTION

Accordingly, the present disclosure is to solve various weak points and problems of the related art as described above, and an objective of the present disclosure is to provide a method and a system thereof for establishing a model for assessing construction site risk levels through deriving BIM-based hazard factors, wherein a classification system of a risk assessment database (DB) is established, which is capable of accumulating actual accident cases by matching a hazard factor profile DB of Construction Safety Management Integrated Information (CSI) based on credible data with a BIM classification system, a linkage is automated between BIM attribute information and the risk assessment DB, and objective risk level reduction measures based on a quantitative risk intensity calculation method and actual accident safety measure cases are presented through risk spaces based on BIM configuration information and a risk occurrence intensity extraction algorithm, so that a method capable of excluding performer's subjectivity is presented, thereby proposing a BIM-based risk assessment model.

Another objective of the present disclosure is to provide a method and a system thereof for establishing a model for assessing construction site risk levels through deriving BIM-based hazard factors, wherein the risk assessment model is configured to increase the safety of construction workers by presenting a quantitative and objective risk calculation method and a reduction measure application method, enable cost reduction in the field of safety management by removing risk in advance from an initial stage of design where the effect of cost input is greatest, have no limitations for the existing methods and has applicability to the new method, improve the understanding and review ability of project participants on construction sites, facilitate communication, accumulate and advance such safety measure data continuously, and make the assessment model available semi-permanently.

In order to achieve the above objectives, there is provided a method of establishing a model for assessing construction site risk levels through deriving BIM-based hazard factors, the method including: step S110 of collecting similar study trends from construction-related partner servers 300 by a construction site risk level assessment server 100 in order to derive the Building

Information Modeling (BIM)-based hazard factors; step S120 of analyzing a CSI hazard factor profile database for the similar study trends among DB content collected through Construction Safety Management Integrated Information (CSI) profile DBs 200; step S130 of collecting construction company development cases and trends; step S200 of establishing a classification system of a risk assessment DB 110, and comprising step S210 of systematizing, in the construction site risk level assessment server 100, a construction site category comprising unnecessary facilities and items, step S220 of deriving a quantitative risk level calculation method comprising occurrence frequency and accident severity, and step S230 of analyzing current risk assessment according to the investigating of other company development cases and trends in step S130; step S300 of developing a framework, and comprising step S310 of deriving a construction site hazard factor visualization method in the construction site risk level assessment server 100, step S320 of developing a risk assessment model framework, and step S330 of deriving a risk level reduction measure application method according to information collected in step S130 of collecting the construction company development cases and trends; step S500 of transmitting BIM-based risk assessment model data from the construction site risk level assessment server 100 to PCs or smart devices of experts and on-site managers preset through participant terminals 400 for a BIM-based risk assessment model in step S400 according to the developed risk assessment model framework in step S320 and the risk level reduction measure application method in step S330, and receiving feedback comprising supplemented data from the participant terminals 400 of participants comprising the experts and the on-site managers; and step S600 of establishing the BIM-based risk assessment model, which is supplemented according to the feedback, in the construction site risk level assessment server 100.

Here, step S320 of developing the risk assessment model framework may include: step S321 of performing 3D modeling based on the classification system of the risk assessment DB 110 by the construction site risk level assessment server 100; step S322 of setting automatic link between attribute information of the BIM and the risk assessment DB 110 by the construction site risk level assessment server 100; step S323 of extracting risk spaces from the attribute information of the BIM by the construction site risk level assessment server 100; step S324 of filtering and visualizing the hazard factors with respect to the extracted risk spaces by the construction site risk level assessment server 100; step S325 of presenting case-based risk level reduction measures for each hazard factor by the construction site risk level assessment server 100; steps S326 and S327 of applying and displaying the risk level reduction measures by the construction site risk level assessment server 100; and step S328 of sorting the hazard factors for each factor and collectively managing the hazard factors, so as to be browsed, by the construction site risk level assessment server 100.

In addition, the method may further include step S421 of deriving response plan materials for responding to the Serious Accident Punishment Act for the BIM-based risk assessment model in step S400 according to the developed risk assessment model framework in step S320 and the risk level reduction measure application method in step S330.

In addition, in order to achieve the above objectives, there is provided a system of establishing a model for assessing construction site risk levels through deriving BIM-based hazard factors, the system including: a construction site risk assessment server 100 configured to investigate precedent studies in fields related to BIM-based safety management, CSI hazard factor profiles, and risk assessment, so as to determine trends in similar technologies, compare and analyze current risk assessment methods, re-establish existing risk rating determination standards for securing quantification and objectivity with respect to targets of the model for assessing the construction site risk levels through deriving the BIM-based hazard factors, systematize a category by classifying hazard factors of accident cases by item, establish a DB classification system for the risk assessment by matching with a BIM classification system, link a built risk assessment DB 110 and a BIM object to present a quantitative risk space extraction method using the BIM, a risk occurrence intensity calculation algorithm, and a construction site hazard factor visualization method by risk occurrence intensity, present a case-based safety measure derivation process for objective risk level reduction measures after confirming calculated risk levels, and report these safety activities to present a plan to be usable as response materials, verify reliability of a model of the safety measure derivation process and report, and provide the method of establishing the model for assessing the construction site risk levels through deriving the BIM-based hazard factors advanced with the construction site risk assessment models; CSI profile databases (DBs) 200 based on an actual construction accident case database, which is fundamental standard data obtained by extracting possible hazard factors at construction sites and classifying the hazard factors by work type; partner servers 300 configured to be servers for construction-related partners that operate the construction sites, and receive technology study trends, various information on the actual construction sites, and the method of establishing the model for assessing the construction site risk levels through deriving the BIM-based hazard factors advanced with the risk assessment models in the construction site risk level assessment server 100; and participant terminals 400 configured to be terminals of safety managers and experts for transmitting and receiving, at a time when the BIM-based hazard factors advanced with the risk assessment models is derived in the construction site risk level assessment server 100, the model of the safety measure derivation process and report with respect to the model for assessing the construction site risk levels through deriving the BIM-based hazard factors and comprising the safety measure derivation process and report.

Here, each CSI profile database (DB) may be configured to include one or more of a DB of the National Disaster Management System of the National Disaster Safety Portal, a DB of the Korea Occupational Safety and Health Agency, a DB of the Facility Management System (FMS), and a DB of the Knowledge Information System of Construction industry (KISCON).

According to an exemplary embodiment of the present disclosure, the following effects are obtained.

First, the embodiment of the present disclosure may increase the safety of construction workers by presenting the quantitative and objective risk level calculation method and the reduction measure application method, and may achieve cost reduction in the field of safety management by removing the risk in advance from the initial stage of design where the effect of cost input is greatest.

Second, the embodiment of the present disclosure may have no limitations to the existing construction methods and have the applicability to the new construction methods, and improve the understanding and review ability of project participants on construction sites and facilitate communication. The embodiment of the present disclosure may accumulate and advance such safety measure data continuously, and make the assessment model available semi-permanently.

Third, all processes may be recorded and reported, and the records and reports may be used as evidence of safety measure performance and response materials for responding to the Serious Accident Punishment Act, etc., so a framework for deriving quantitative risk levels on the basis of BIM is proposed, whereby the framework may be used as a base technology in the field of risk assessment using BIM in the future.

### BRIEF DESCRIPTION OF THE DRAWINGS

FIG. 1 illustrates a block diagram for describing an exemplary embodiment of a system of assessing construction site risk levels through deriving BIM-based hazard factors according to the present disclosure.

FIG. 2 illustrates a flowchart for describing an exemplary embodiment of a method of establishing a model for assessing construction site risk levels through deriving BIM-based hazard factors according to the present disclosure.

FIG. 3 is a view for describing an exemplary embodiment of a risk assessment model framework in the method of establishing the model for assessing the construction site risk levels through deriving the BIM-based hazard factors according to the present disclosure.

FIG. 4 is a flowchart for describing an exemplary embodiment of a risk space extraction algorithm in the method of establishing the model for assessing the construction site risk levels through deriving the BIM-based hazard factors according to the present disclosure.

FIG. 5 is a view for describing an exemplary risk space extraction model in the method of establishing the model for assessing the construction site risk levels through deriving the BIM-based hazard factors according to the present disclosure.

FIGS. 6 to 11 are views for describing examples of risk space extraction in the method of establishing the model for assessing the construction site risk levels through deriving the BIM-based hazard factors according to the present disclosure.

FIG. 12 is a view for describing an example of browsing risk information in risk spaces in the method of establishing the model for assessing the construction site risk levels through deriving the BIM-based hazard factors according to the present disclosure.

FIG. 13 is a view for describing an example of applying a risk level reduction measure (primary) in the method of establishing the model for assessing the construction site risk levels through deriving the BIM-based hazard factors according to the present disclosure.

FIGS. 14 and 15 are views for describing examples of applying a detailed risk level reduction measure (secondary) in the method of establishing the model for assessing the construction site risk levels through deriving the BIM-based hazard factors according to the present disclosure.

FIG. 16 is a view for describing an example of sort and collective management for each hazard factor in the method of establishing the model for assessing the construction site risk levels through deriving the BIM-based hazard factors according to the present disclosure.

FIG. 17 is a view for describing an example of an assessment model utilization method the according to the method of establishing the model for assessing the construction site risk levels through deriving the BIM-based hazard factors according to the present disclosure.

FIG. 18 is an exemplary view of recording and reporting safety measures according to the method of establishing the model for assessing the construction site risk levels through deriving the BIM-based hazard factors according to the present disclosure.

### DETAILED DESCRIPTION OF THE INVENTION

Preferred exemplary embodiments of the present disclosure will be described in detail with reference to the accompanying drawings.

As terms used in the present disclosure, general terms that are currently widely used are selected as much as possible, but in particular cases, there are terms arbitrarily selected by the applicant. In this case, since the meaning of each term has been described in detail in the description of the corresponding disclosure, it should be made clear that the present disclosure should be understood with the meanings of the terms rather than the simple names of the terms. In addition, in describing the exemplary embodiments, descriptions of technical content that are well known in the technical field to which the present disclosure pertains and are not directly related to the present disclosure will be omitted. This is to more clearly convey the gist of the present disclosure without obscuring the present invention by omitting unnecessary description.

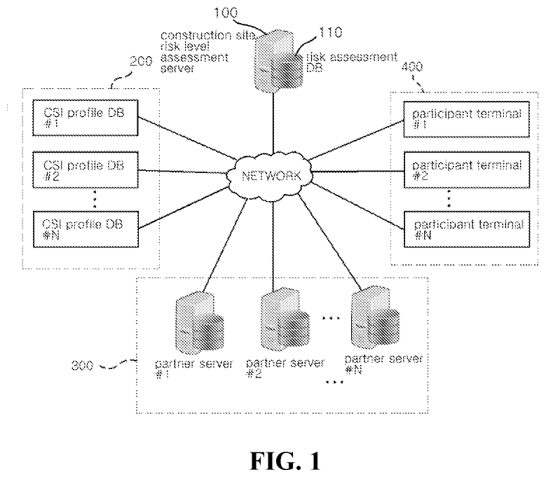

FIG. 1 illustrates a block diagram for describing an exemplary embodiment of a construction site risk level assessment system through deriving BIM-based hazard factors according to the present disclosure.

As shown in FIG. 1, the exemplary embodiment of the system of assessing construction site risk levels through deriving the BIM-based hazard factors according to the present disclosure is configured to include a construction site risk level assessment server 100, a risk assessment database 110, Construction Safety Management Integrated Information (hereinafter abbreviated as CSI) profile databases 200, partner servers 300, and participant terminals 400.

Here, the construction site risk level assessment server 100 investigates precedent studies in fields related to BIM-based safety management, CSI hazard factor profiles, and risk assessment, so as to identify trends in similar technologies, and compare and analyze current risk assessment methods. Specifically, the construction site risk level assessment server 100 is configured to analyze case study targets, optimize a risk assessment model for the targets, re-establish existing risk rating determination standards for securing quantification and objectivity, systematize a category by classifying hazard factors of accident cases by item, establish a DB classification system for risk assessment by matching with a BIM classification system, link a built risk assessment DB and a BIM object to present a quantitative risk space extraction method using BIM, a risk occurrence intensity calculation algorithm, and a construction site hazard factor visualization method by risk occurrence intensity, present a case-based safety measure derivation process for objective risk level reduction measures after confirming calculated risk levels, and report these safety activities to present a plan to be usable as response materials for responding to various laws and regulations (e.g., the Serious Accident Punishment Act, etc.). In addition, reliability of a model of the safety measure derivation process and report and others is verified through consultation with safety managers and experts, a survey of a questionnaire is conducted on differentiation of the present disclosure and a current risk assessment level, and a survey result is analyzed with the technique of Importance Performance Analysis (IPA), thereby verifying on-site applicability. In addition, by reflecting the verification result and feedback from workers such as on-site managers and supplementing the process, thereby providing the method of establishing the model for assessing the construction site risk levels through deriving the BIM-based hazard factors advanced with risk assessment models of construction sites.

The risk assessment database (DB) 110 is a database in which actual accident cases are accumulated.

For reference, there are many definitions of a hazard, a risk, and risk assessment. According to Construction Safety Management Integrated Information (CSI, 2021) of the Ministry of Land, Infrastructure, and Transport, a hazard factor is referred to as a harmful risk and an occurrence possibility thereof, which impair safety, and is defined as factors that may not be avoided but reduced. In addition, the risk is defined as occurrence frequency and accident severity, and a reduction measure (i.e., an alternative) is defined as a preventive measure that may reduce hazard factors and lower the risk. In addition, according to most safety management guidelines, the risk is a combination of the occurrence probability of a disaster and intensity thereof, and is defined as predicting a magnitude of the risk by deriving the occurrence probability inherent in the risk and intensity thereof.

A risk is defined to include: accident severity, which is calculated on the basis of scales of human damage and material damage, which are caused by an accident when the accident has occurred; and accident frequency, which is calculated on the basis of the number of accidents based on a predetermined period. This means that the risk is high not only when a magnitude of damage caused by the accident is large, but also when the accident occurs frequently even though the magnitude of the damage is relatively small. Thus, the risk is derived by comprehensively calculating the severity and frequency of such an accident.

Risk assessment is defined as that occurrence frequency (i.e., likelihood) of an accident and accident severity are calculated and combined with each other to derive a comprehensive risk, and apply a reduction measure (i.e., an alternative) to reduce a risk level.

The CSI profile databases (DBs) 200 are based on an actual construction accident case database, as fundamental standard data, that extracts hazard factors that may occur at construction sites and classifies the extracted hazard factors by work type. Such CSI profile databases (DBs) are capable of extracting accident information through a DB of the National Disaster Management System of the National Disaster Safety Portal and a DB of the Korea Occupational Safety and Health Agency, extracting facility information through a DB of the Facility Management System (FMS), and extracting construction information through a DB of the Knowledge Information System of Construction industry (KISCON). Such CSI profile databases (DBs) 200 may be composed of a plurality of CSI profile DBs #1 to #3.

The partner servers 300 are servers of construction-related partners that operate construction sites and collect various information, which is for analysis of technology study trends, on the actual construction sites, or are provided with the method of establishing the model for assessing the construction site risk levels through deriving the BIM-based hazard factors advanced with risk assessment models from the construction site risk level assessment server 100.

The participant terminals 400 are terminals of safety managers an experts, and are terminals to transmit/receive a model of a safety measure derivation process and report and others in order to verify reliability of the model of the safety measure derivation process and report and others through consultation with the safety managers and experts when the BIM-based hazard factors advanced with the risk assessment models are derived from the construction site risk level assessment server 100. Each participant terminal 400 may be configured with a PC, a smart device (e.g., a smart pad, a smartphone).

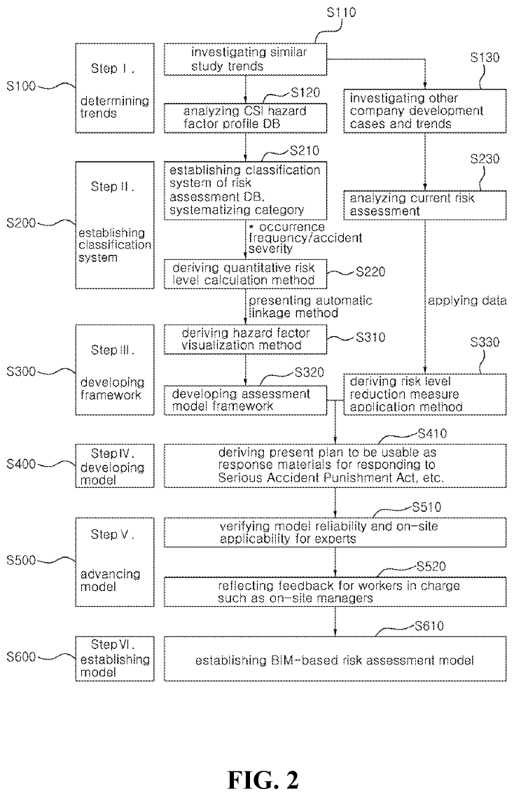

FIG. 2 illustrates a flowchart for describing the exemplary embodiment of the method of establishing the model for assessing the construction site risk levels through deriving the BIM-based hazard factors according to the present disclosure.

In the exemplary embodiment of the method of establishing the model for assessing the construction site risk levels through deriving the BIM-based hazard factors according to the present disclosure, as shown in FIG. 2, in step S100, trends are determined in order to derive BIM-based hazard factors.

In such determining of the trends, similar study trends are collected (i.e., investigated) in step S110 from the partner servers 300 through collaboration with a plurality of partners (e.g., construction companies) in the construction site risk level assessment server 100, and in step S120, CSI profile DBs (i.e., hazard factor profile DBs) for the similar study trends collected through the CSI profile DBs 200 are analyzed. In this case, development cases of other companies and the trends may be collected (i.e., investigated) in step S130 when the similar study trends are collected. Such similar studies are to collect existing precedent studies, and for example, include precedent studies related to risk assessment, precedent studies related to BIM safety management, precedent studies on BIM-based risk, etc.

Such existing BIM-based safety management and risk assessment studies use BIM in the field of safety management to increase accuracy of hazard factor derivation by using methods such as construction site hazard factor visualization or propose precautionary risk measures for a risk through presenting a quantitative risk level derivation method when calculating risk levels of risk assessment. As a result of analyzing and comparing the precedent studies according to whether each item is reflected or not, it may be seen that various studies for applying BIM have been conducted by way of using the BIM in the field of safety management, presenting the quantitative risk level calculation method, etc. However, the precedent studies merely secure results from one of the methods of presenting the precautionary risk measures and deriving the quantitative risk levels, but there are no studies conducted in parallel with these two methods. In the present disclosure, by calculating quantitative risk occurrence intensity based on BIM and calculating objective risk probability based on actual accident cases, subjectivity in risk reduction is eliminated and measures against risk are taken in advance, so that a risk assessment model framework capable of securing the efficiency of safety activity costs may be proposed.

Meanwhile, Table 1 compares current risk assessment techniques.

TABLE 1

| Analysis | | Precautionary | Risk rating | Quantitative |
|---|---|---|---|---|
| technique | Summary | risk measures | basis or not | risk level |
| HAZOP | Proceeding with a | • | • | X |
| | brainstorming method using | | | |
| | Guide Word | | | |
| JSA | A method of classifying | X | X | X |
| | specific tasks to identify and | | | |
| | prevent potential accidents | | | |
| | at each stage | | | |
| HEA | Evaluating factors, which | • | ▴ | ▴ |
| | will affect work, by a | | | |
| | worker (design changes, etc.) | | | |
| K-PSR | Re-examining or analyzing | X | X | X |
| | process safety after risk | | | |
| | assessment | | | |
| Checklist | Adjusting and verifying a | • | • | X |
| | project by using a checklist | | | |
| What-if | By assuming an undesirable | • | • | X |
| | event to occur, predicting an | | | |
| | outcome and preparing | | | |
| | measures | | | |
| PHA | Performing in advance of | • | ▴ | X |
| | other risk analysis and | | | |
| | estimating possible potential | | | |
| | risks | | | |
| CCA | Predicting a correlation | • | X | ▴ |
| | between a cause and a result | | | |
| | of a potential accident | | | |
| FMECA | Identifying systems, | ▴ | • | ▴ |
| | facilities, etc. that directly | | | |
| | cause serious accidents | | | |
| FTA | Determining a cause of a | ▴ | X | • |
| | specific accident to occur | | | |
| ETA | Assessing potential accident | • | X | ▴ |
| | consequences arising from | | | |
| | an initial incident | | | |
| DMI | Providing chemical plants | • | X | X |
| | with simple and direct | | | |
| | relative risk rankings of | | | |
| | risks | | | |
| LOPA | Repeating a risk assessment | • | • | ▴ |
| | procedure for specific | | | |
| | accident scenarios | | | |
| CA | Calculating the extent of | X | X | • |
| | damage impact in the event | | | |
| | of an accident | | | |

*•: Reflecting specifically
▴: reflecting partially
X: no reflection

As shown in Table 1, there are various risk assessment and analysis techniques to date, but as a result of the comparison therebetween, there is no technique satisfies all the key elements. In addition, there are few techniques capable of quantitatively calculating risk levels. The reason is that human errors such as the duplication and omission of hazard factors may occur due to involvement of performer subjectivity when the risk levels are calculated, and due to dependency on the knowledge and experience of a performer, the effectiveness of risk assessment for construction is lowered by the performer who has not been experienced new technology and new construction methods. Accordingly, the present disclosure is devised to use BIM to secure quantification and present a case-based risk assessment method, so as to propose the risk assessment model capable of objectively assisting the performer's subjective determination.

In this way, the embodiment of the present disclosure is capable of selecting and analyzing actual companies in order to identify problems in the current risk assessment and verify applicability of the proposed model. In this regard, interviews are conducted with safety managers of respective companies and the corresponding content are collected as trend data in the construction site risk level assessment server 100.

Next, in step S200, a classification system of a risk assessment DB 110 is established in the construction site risk level assessment server 100.

The establishing of such a classification system includes: step S210 of establishing the classification system of the risk assessment DB 110 and systemizing a category; and step S220 of deriving a quantitative risk level calculation method. For reference, the establishing of the classification system of the risk assessment DB 110 and the systemizing of the category in step S210 includes content of current risk assessment analysis in step S230 according to the investigating of other company development cases and trends in step S130, and includes occurrence frequency and accident severity, unnecessary facilities, and items. Even in this case, the required development cases or the risk assessment data obtained from the corresponding partners, and the like may be collected from partner servers 300.

That is, through the above interviews conducted with the plurality of companies, items repeatedly mentioned and items having high importance are derived, and by referring to these items, a method to solve the problem of not being able to determine hazard factors early and a quantitative method for objective risk assessment are allowed to be applied. In addition, by using BIM, a DB classification system of hazard factors for calculating additional safety check factors and accident case-based risk levels is established, and determination of hazard factors with respect to confinement and falls are enabled.

Next, in step S300, a framework is developed in the construction site risk level assessment server 100.

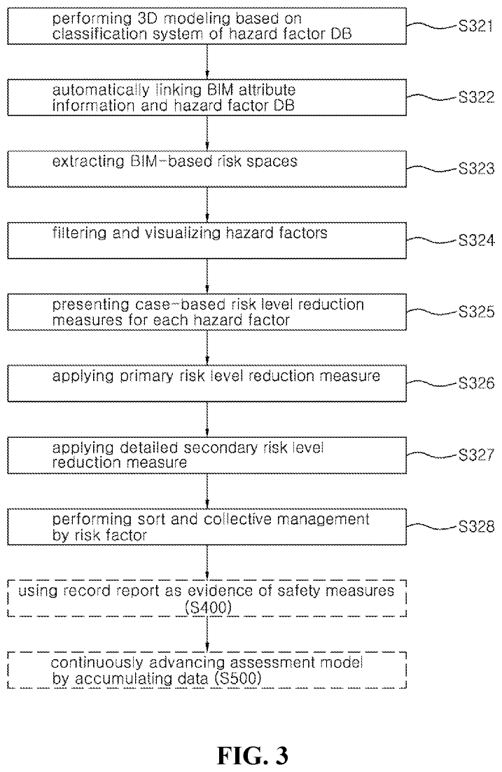

The developing of such a framework includes: deriving a hazard factor visualization method in step S310 according to the quantitative risk level calculation method in step S220; and developing an assessment model framework in step S320. Meanwhile, in step S310 of deriving the hazard factor visualization method, an automatic linkage method is presented. Such a framework will be described in more detail with reference to FIG. 3.

FIG. 3 is a view for describing an exemplary embodiment of a risk assessment model framework in the method of establishing the model for assessing the construction site risk levels through deriving the BIM-based hazard factors according to the present disclosure.

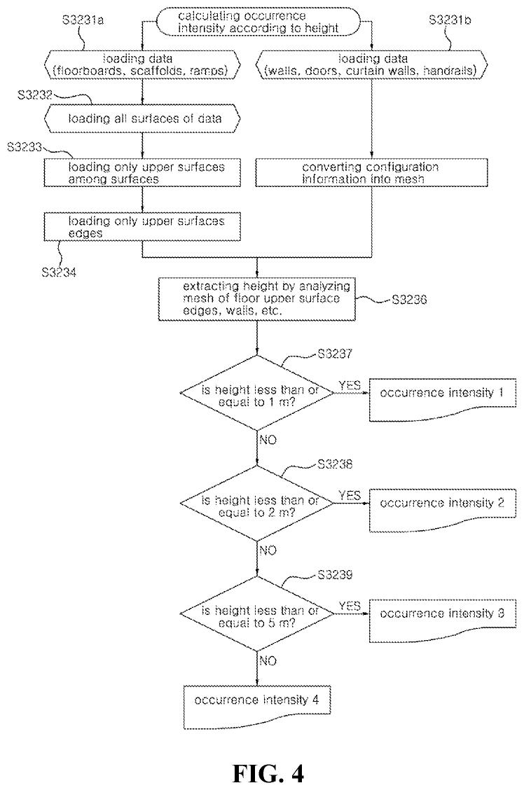

FIG. 4 is a flowchart for describing an exemplary embodiment of a risk space extraction algorithm in the method of establishing the model for assessing the construction site risk levels through deriving the BIM-based hazard factors according to the present disclosure.

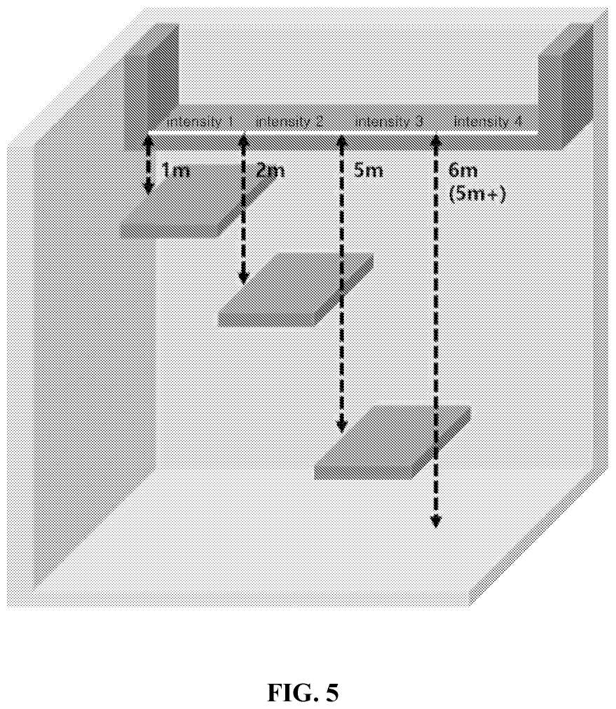

FIG. 5 is a view for describing an exemplary risk space extraction model in the method of establishing the model for assessing the construction site risk levels through deriving the BIM-based hazard factors according to the present disclosure.

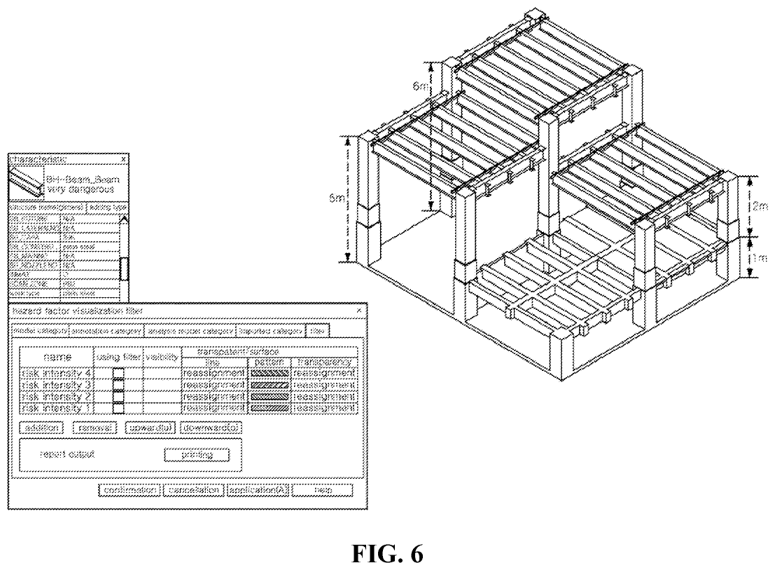

FIGS. 6 to 11 are views for describing examples of risk space extraction in the method of establishing the model for assessing the construction site risk levels through deriving the BIM-based hazard factors according to the present disclosure.

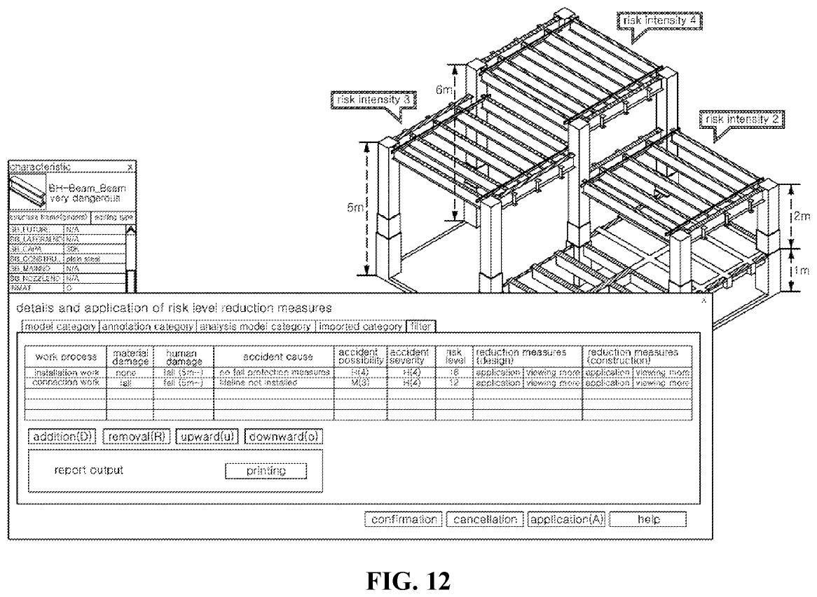

FIG. 12 is a view for describing an example of browsing risk information in risk spaces in the method of establishing the model for assessing the construction site risk levels through deriving the BIM-based hazard factors according to the present disclosure.

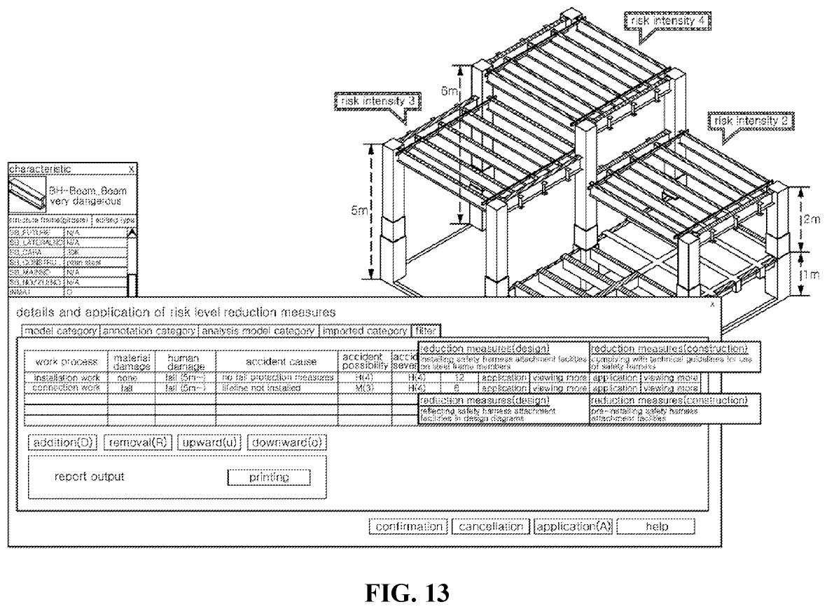

FIG. 13 is a view for describing an example of applying a risk level reduction measure in the method of establishing the model for assessing the construction site risk levels through deriving the BIM-based hazard factors according to the present disclosure.

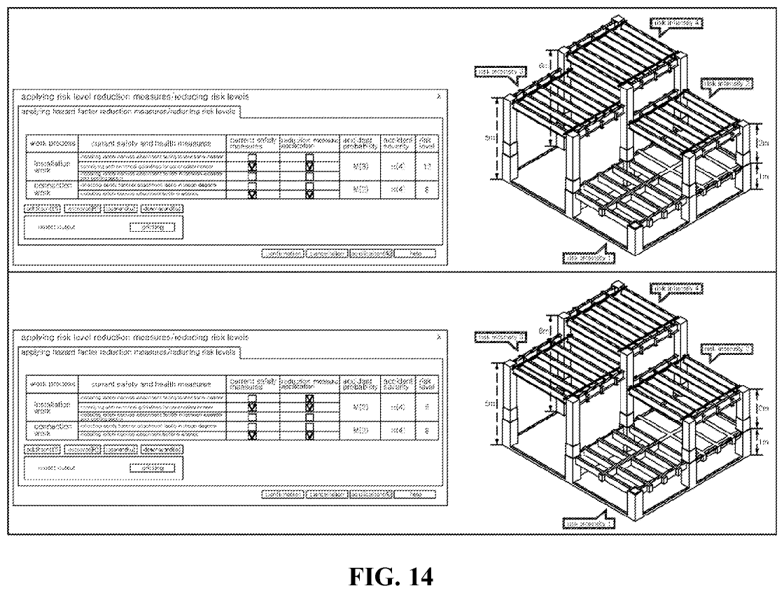

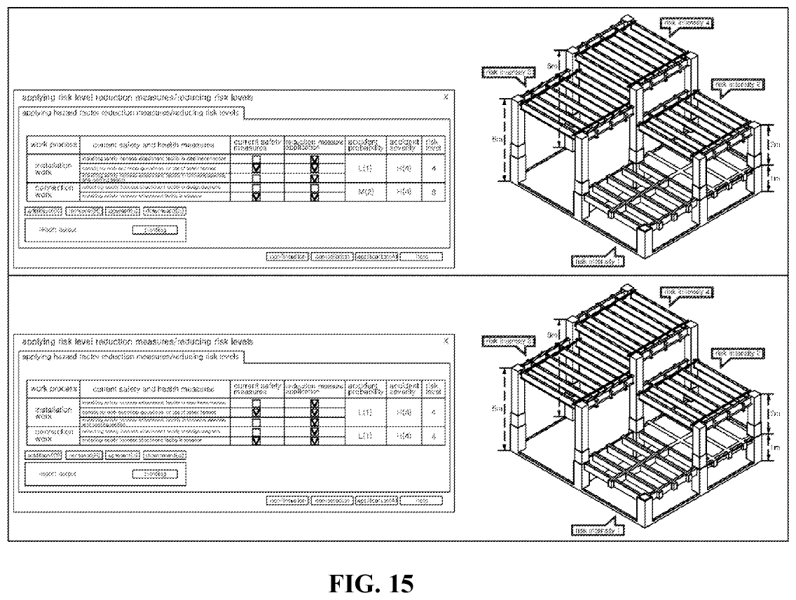

FIGS. 14 and 15 are views for describing examples of applying a detailed risk level reduction measure in the method of establishing the model for assessing the construction site risk levels through deriving the BIM-based hazard factors according to the present disclosure.

In the method of establishing the model for assessing the construction site risk levels through deriving the BIM-based hazard factors according to the present disclosure, the exemplary embodiment of the risk assessment model framework performs 3D modeling on the basis of the classification system of the risk assessment DB (i.e., a hazard factor DB) as shown in FIG. 3 in step S321.

In this regard, first, in order to establish the classification system of the risk assessment DB (i.e., the hazard factor DB), the CSI hazard factor profile DB 200 is referred. The CSI extracts hazard factors that may occur at construction sites and classifies the hazard factors by work type, so as to produce fundamental standard data. In this regard, actual construction accident case data is used as a basis, and in order to prevent construction accidents, a hazard factor profile is established and supported, so as to be referred to for reviewing design safety and establishing safety management plans. Currently, a total of 25,911 records of the data are accumulated for the years of 2020 and 2021. In addition, as described above, as the CSI profile DB, the accident information is collected from the national disaster management system and the Korea Occupational Safety and Health Agency, and authoritative data is collected from the Facility Management System, the Knowledge Information System of Construction industry, and others. The classification system of the risk assessment DB (i.e., the hazard factor DB) is established by using the data generated by the CSI.

First, the CSI risk assessment DB (i.e., the hazard factor DB) and BIM design standards are analyzed, and a category of unnecessary facilities, items, etc. is changed and removed. Next, the unnecessary data, duplicate items, and similar items are removed according to the change/removal of the category. Lastly, the existing names of work types are matched and improved into names of work types of the risk assessment DB. The 3D modeling of design drawings should be performed on the basis of the classification system of the risk assessment DB established in this way.

Such a classification system of the risk assessment DB (the hazard factor DB) subdivides all accidents and presents classifiable standards for adaptability and work performance, thereby having strong points of reducing accessibility, increasing accuracy, facilitating communication between performers, and reducing omissions of important work.

Next, in step S322, BIM attribute information and the risk assessment DB (the hazard factor DB) are automatically linked to each other.

The risk assessment DB built in this way may be automatically linked with the attribute information of a BIM model, thereby reducing additional work. For example, when SheetLink, which is an add-on distributed free of charge by Autodesk, is used, an export/import function is usable between BIM and MS Excel. By using this function, the hazard factors are inserted into the BIM attribute information when the BIM attribute information is exported, the data of the risk assessment DB corresponding to the BIM attribute information is input, and then MS Excel is imported from the BIM again. When such a process is automated through plug-ins, add-ons, etc., the work of risk assessment using BIM may be effectively reduced.

Subsequently, in step S323, BIM-based risk spaces are extracted from the BIM attribute information.

Information on such hazard factors may be inserted into BIM, but risk levels inserted in this way are based on the data from the CSI. The CSI also calculates quantitative risk levels by using its own standards and data, but only by deriving hazard factors on the basis of risk level calculation standards, appropriate accuracy of results may be secured.

In the present disclosure, for the purpose of risk level calculation, realistic fall risk occurrence intensity is calculated as shown in Table 2 below, and a risk space extraction algorithm is developed by using the calculated fall risk occurrence intensity standard.

TABLE 2

| Risk intensity | Standard |
|---|---|
| 1 | Less than or equal to 1 m in height |
| 2 | 1 m~2 m in height |
| 3 | 2 m~5 m in height |
| 4 | Greater than or equal to 5 m in height |

The risk space extraction algorithm based on such heights is as shown in FIG. 4. Describing the risk space extraction algorithm, the construction site risk level assessment server 100 loads data. Such loading of the data includes: step S3231a of loading data of floorboards, scaffolds, and ramps; and step S3231b of loading data of walls, doors, curtain walls, handrails, etc.

In addition, after loading, in step S3231a, the data of the floorboards, scaffolds, and ramps, which are targets of risk assessment, all surfaces of the data are loaded in step S3232, and only upper surfaces among the surfaces are loaded in step S3233. In addition, in step S3234, only edges of the upper surfaces are loaded.

In addition, after loading the data of the floorboards, scaffolds, and ramps of the targets of the risk assessment in step S3231b, configuration information is converted into a mesh in step S3235.

Afterwards, in step S3236, the construction site risk level assessment server 100 analyzes the mesh of the floor upper surface edges, walls, etc., so as to extract a height. In addition, risk occurrence intensity (i.e., risk intensity) is determined according to whether the height is one meter or less in step 3237, two meters or less in step S3238, or five meters or less in step S3239.

Meanwhile, respective risk spaces derived may be displayed on corresponding members in different colors (e.g., intensity 1 is green, intensity 2 is yellow, intensity 3 is orange color, and intensity 4 is red) by risk occurrence intensity, and the extracted risk spaces may be filtered, so that a selective visualization method may be proposed as shown in FIG. 5.

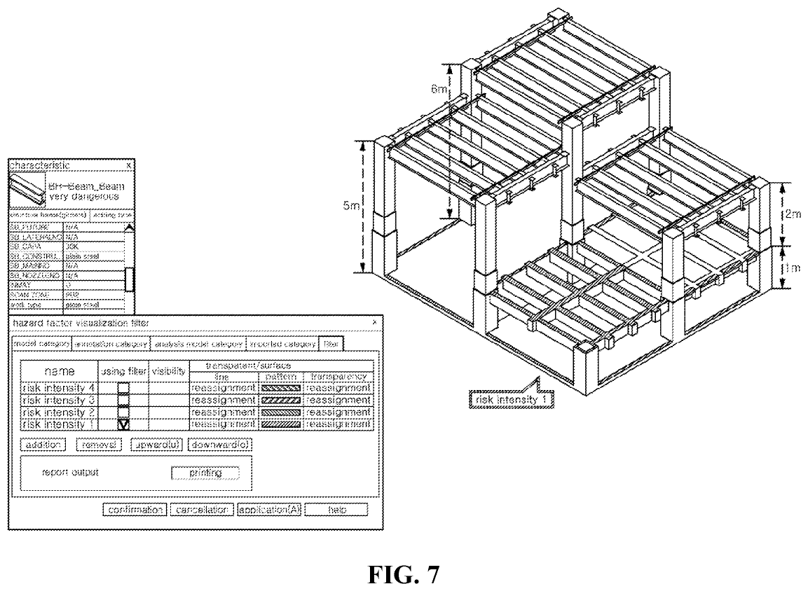

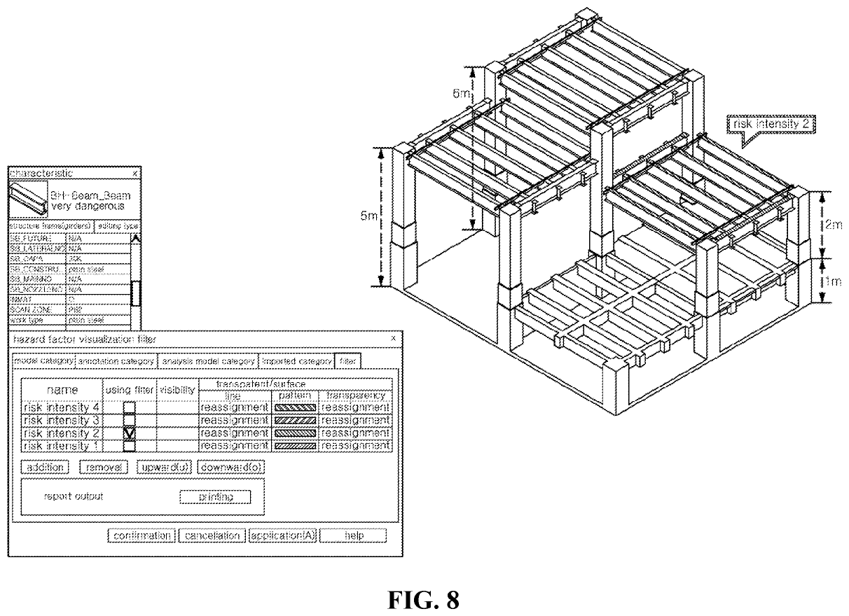

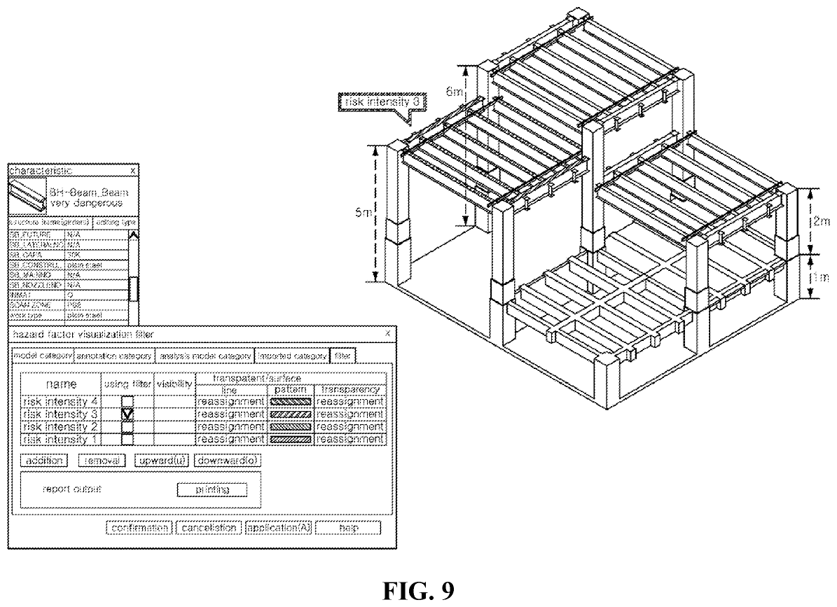

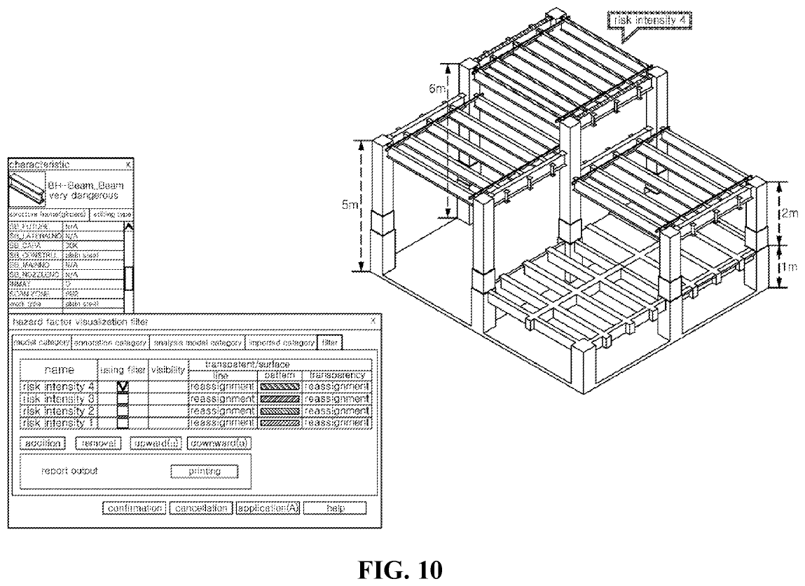

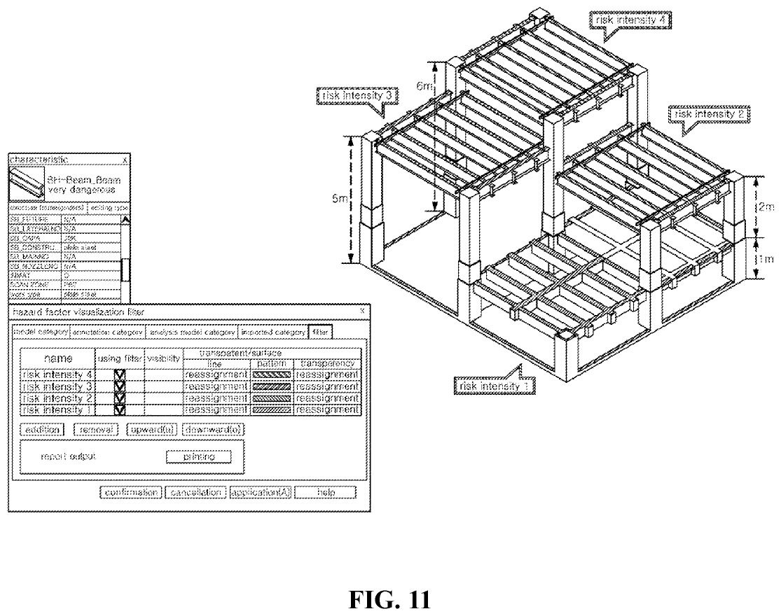

In addition, in step S324, hazard factors may be visualized by means of filtering, a monitor, etc. Such visualization of the hazard factors is as shown in FIGS. 6 to 11. FIG. 6 is a fundamental view of an example of hazard factor extraction. FIG. 7 is an exemplary view of risk intensity 1 among risk space extraction examples, FIG. 8 is an exemplary view of risk intensity 2 among risk space extraction examples, FIG. 9 is an exemplary view of risk intensity 3 among risk space extraction examples, and FIG. 10 is an exemplary view of risk intensity 4 among risk space extraction examples. FIG. 11 is an exemplary view of risk space extraction for the entire risk intensity. In this case, FIG. 7 illustrates the example in which the risk intensity 1 is visualized in green, FIG. 8 illustrates the example in which the risk intensity 2 is visualized in yellow, FIG. 9 illustrates the example in which the risk intensity 3 is visualized in orange color, and FIG. 10 illustrates the example in which the risk intensity 4 is visualized in red,

In this way, in step S325, after performing the visualization of the hazard factors, case-based risk level reduction measures for each hazard factor are presented (e.g., on the monitor). In this case, FIG. 12 is the view for describing the example of browsing the risk information in the risk spaces in the method of establishing the model for assessing the construction site risk levels through deriving the BIM-based hazard factors according to the present disclosure, wherein, when the risk spaces are extracted, pieces of information on the hazard factors are linked and automatically input, data of the risk information linked to corresponding risk occurrence intensity and attribute information is output, and pieces of information such as risk levels are derived on the basis of data-based accident possibility and accident severity. FIG. 12 illustrates that the risk information for a steel frame at a height of 6 m and risk occurrence intensity of 4 (i.e., very dangerous) are derived. Accordingly, respective overall risk indices applied with risk frequency are indicated as 16 (i.e., unacceptable) and 12 (i.e., significant risk). Therefore, it may be concluded that risk level reduction measures are required.

According to the hazard factors derived in this way, the risk level reduction measures in a design stage and a construction stage are presented from the construction site risk level assessment server 100 to the partner servers 300 on a case-by-case basis, and a performer (i.e., an implementer) may apply the risk level reduction measures by way of applying and selecting the risk levels and characteristics of a work site. In steps S326 and S327, these reduction measures may be applied as, for example, a primary reduction measure and a secondary reduction measure, and display the applied results on the monitor.

For example, the primary risk level reduction measure is an exemplary measure of applying “compliance with technical guidelines for the use of safety harnesses”, which is a construction stage reduction measure against “not taking measures to prevent falls”, which is the cause of an accident involving the risk of falling in steel frame member installation work, and applying “pre-installation of safety harness attachment facilities”, which is a construction stage reduction measure against “not installing harnesses”, which is the cause of an accident involving the risk of falling in connection work. It may be confirmed that the existing risk levels are 16 (unacceptable) and 12 (significant risk), respectively, but after the risk level reduction is applied, the risk levels are decreased to 12 (significant risk) and 8 (significant risk), respectively. FIG. 13 illustrates the view for describing the example of applying the risk level reduction measure (primary) in the method of establishing the model for assessing the construction site risk levels through deriving the BIM-based hazard factors according to the present disclosure.

Meanwhile, FIGS. 14 and 15 are views for describing the example of applying the detailed risk level reduction measure (secondary) in the method of establishing the model for assessing the construction site risk levels through deriving the BIM-based hazard factors according to the present disclosure. As shown in FIG. 13, since the risk occurrence intensity is a risk level for a hazard factor having a risk occurrence intensity of 4 (very dangerous), the risk level is still maintained high even though the primary risk level reduction measure is applied. Accordingly, application of additional risk level reduction measures for this case is required, and FIGS. 14 and 15 illustrates about this case.

That is, when risk level reduction measures are applied in detail, all risk level reduction measures for the corresponding hazard factors, including the risk level reduction measure applied in the primary measure, are presented. For example, it is possible to reduce a risk level by selecting and applying, to the currently selected measures, additional reduction measures in consideration of the characteristics and conditions of a work site. As shown in an exemplary view (1) of FIG. 14, it may be confirmed that the risk level 12 (significant risk) is reduced to a risk level 8 (significant risk). In this way, reduction may be conducted until each risk level becomes at an acceptable level.

In an exemplary view (2) of FIG. 15, hazard factors having the respective risk levels 12 20 (major risk) and 8 (major risk) after conducting the primary risk level reduction are all reduced to a risk level of 4 (minor risk) through the application of the additional reduction measures. In general, it may be confirmed that the risk levels have become the risk work levels acceptable with no additional safety measure.

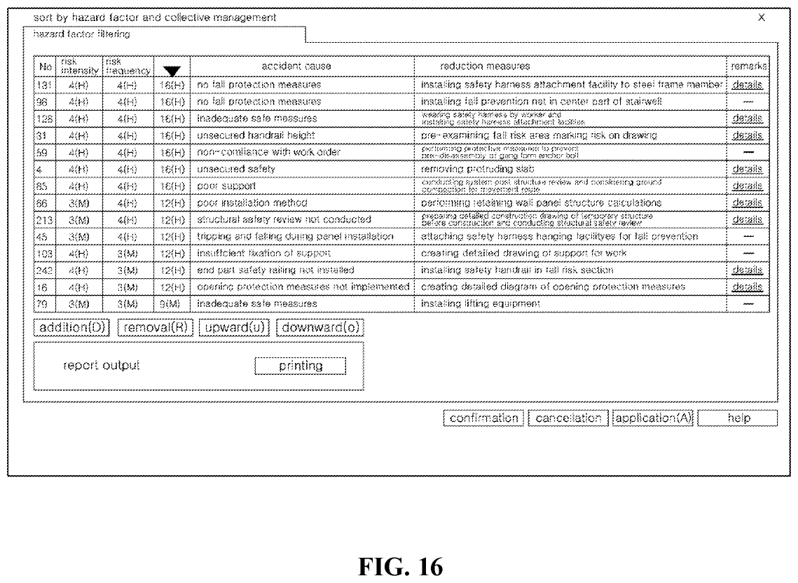

As described above, as proposed in FIGS. 14 and 15, since hazard factors that have been reduced or need to be reduced may be sorted according to risk levels and classification items, and only required information may be filtered and browsed or collectively managed, the hazard factors may also be usable from a safety management point of view. This is shown in FIG. 16.

FIG. 16 is a view for describing an example of sort and collective management for each hazard factor in the method of establishing the model for assessing the construction site risk levels through deriving the BIM-based hazard factors according to the present disclosure. Since the hazard factors that have been reduced or need to be reduced may be sorted according to risk levels and classification items, and only required information may be filtered and browsed or collectively managed, the hazard factors may also be usable from the safety management point of view.

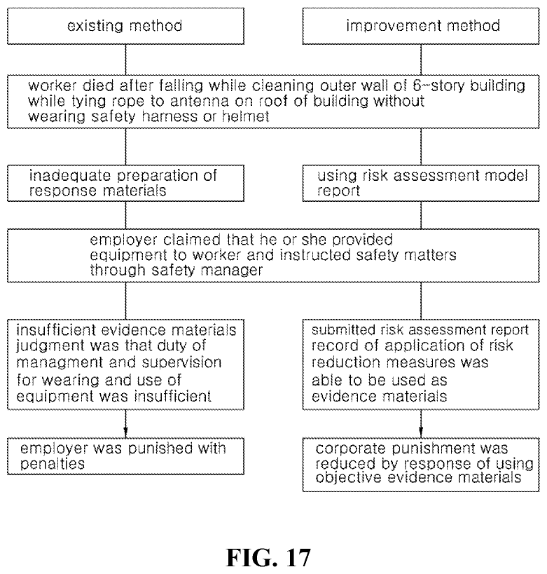

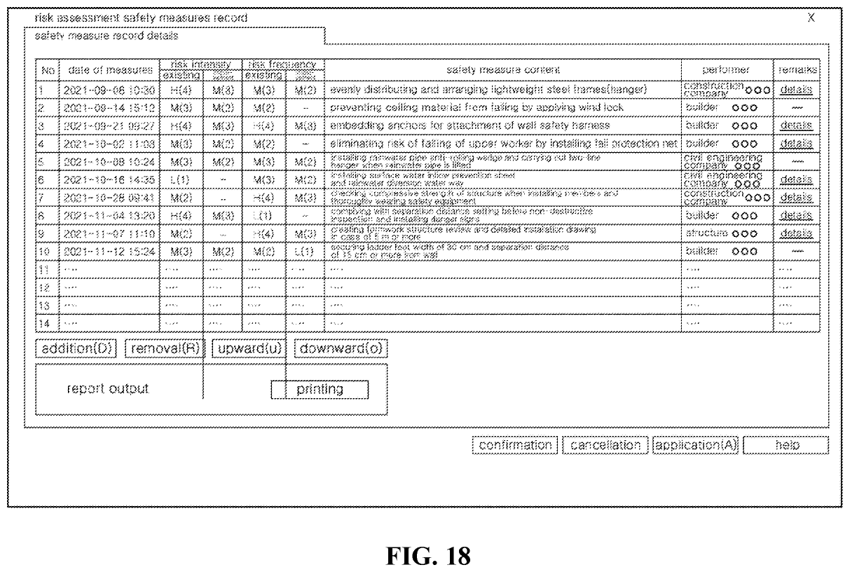

Meanwhile, FIG. 17 is a view for describing an example of an assessment model utilization method according to the method of establishing the model for assessing the construction site risk levels through deriving the BIM-based hazard factors according to the present disclosure. FIG. 18 is an exemplary view of recording and reporting safety measures according to the method of establishing the model for assessing the construction site risk levels through deriving the BIM-based hazard factors according to the present disclosure. In the case of the existing method, there is a possibility that a business owner may be punished by a fine and the like, due to insufficient preparation of response materials, but according to an improvement plan, it is shown that punishment of a company may be reduced by responding with objective evidence materials based on the example of the safety measure records and report as shown in FIG. 18.

According to the assessment model framework in step S320 and the risk level reduction measure application method in step S330, which are developed in the framework development in step S300, a model is developed in step S400 by way of including derivation of a plan to be used as the response materials for responding to the Serious Disaster Punishment Act, and the like in step 410.

Meanwhile, after developing the BIM-based risk assessment model in step S400, the BIM-based risk assessment model is required to be advanced in step S500.

Such advancement work includes verifying model reliability and on-site applicability for experts in step S510, and reflecting feedback for workers in charge such as on-site managers in step S520. Even in this case, the construction site risk level assessment server 100 transmits BIM-based risk assessment model data to PCs or smart devices of the experts (i.e., the professors, etc.) and the on-site managers, who are preset through each participant terminal 400, and receives the feedback.

When the advancing of the BIM-based risk assessment model is completed, the BIM-based risk assessment model is finally established in step S600. In step S610, the BIM-based risk assessment model is finally established according to the results of the above-described verifying of the model reliability and on-site applicability for the experts in step S510, and the reflecting of the feedback for the workers in charge such as the on-site managers in step S520.

Although the present disclosure has been described with the above examples, the present disclosure is not necessarily limited to these examples, and may be variously modified and implemented without departing from the technical spirit of the present disclosure. Therefore, the exemplary embodiments disclosed in the present disclosure are not intended to limit the technical idea of the present disclosure but to describe the present disclosure, and the scope of the technical idea of the present disclosure is not limited by these exemplary embodiments. The scope of protection of the present disclosure should be interpreted by the following claims, and all technical ideas within the scope equivalent thereto should be construed as being included in the scope of the present disclosure.

What is claimed is:

1. A method of establishing a model for assessing construction site risk levels through deriving BIM-based hazard factors, the method comprising:
step S110 of collecting similar study trends from construction-related partner servers (300) by a construction site risk level assessment server (100) in order to derive the Building Information Modeling (BIM)-based hazard factors;
step S120 of analyzing a CSI hazard factor profile database for the similar study trends among DB content collected through Construction Safety Management Integrated Information (CSI) profile DBs (200);
step S130 of collecting construction company development cases and trends;
step S200 of establishing a classification system of a risk assessment DB (110), and comprising
step S210 of systematizing, in the construction site risk level assessment server (100), a construction site category comprising unnecessary facilities and items,
step S220 of deriving a quantitative risk level calculation method comprising occurrence frequency and accident severity, and
step S230 of analyzing current risk assessment according to the investigating of other company development cases and trends in step S130;
step S300 of developing a framework, and comprising
step S310 of deriving a construction site hazard factor visualization method in the construction site risk level assessment server (100),
step S320 of developing a risk assessment model framework, and
step S330 of deriving a risk level reduction measure application method according to information collected in step S130 of collecting the construction company development cases and trends;
step S500 of transmitting BIM-based risk assessment model data from the construction site risk level assessment server (100) to PCs or smart devices of experts and on-site managers preset through participant terminals (400) for a BIM-based risk assessment model in step S400 according to the developed risk assessment model framework in step S320 and the risk level reduction measure application method in step S330, and receiving feedback comprising supplemented data from the participant terminals (400) of participants comprising the experts and the on-site managers; and
step S600 of establishing the BIM-based risk assessment model, which is supplemented according to the feedback, in the construction site risk level assessment server (100).

2. The method of claim 1, wherein step S320 of developing the risk assessment model framework comprises:
step S321 of performing 3D modeling based on the classification system of the risk assessment DB (110) by the construction site risk level assessment server (100);
step S322 of setting automatic link between attribute information of the BIM and the risk assessment DB (110) by the construction site risk level assessment server (100);
step S323 of extracting risk spaces from the attribute information of the BIM by the construction site risk level assessment server (100);
step S324 of filtering and visualizing the hazard factors with respect to the extracted risk spaces by the construction site risk level assessment server (100);
step S325 of presenting case-based risk level reduction measures for each hazard factor by the construction site risk level assessment server (100);
steps S326 and S327 of applying and displaying the risk level reduction measures by the construction site risk level assessment server (100); and,
step S328 of sorting the hazard factors for each factor and collectively managing the hazard factors, so as to be browsed, by the construction site risk level assessment server (100).

3. The method of claim 1, further comprising:
step S421 of deriving response plan materials for responding to the Serious Accident Punishment Act for the BIM-based risk assessment model in step S400 according to the developed risk assessment model framework in step S320 and the risk level reduction measure application method in step S330.

4. A system of establishing a model for assessing construction site risk levels through deriving BIM-based hazard factors, the system comprising:
a construction site risk assessment server (100) configured to investigate precedent studies in fields related to BIM-based safety management, CSI hazard factor profiles, and risk assessment, so as to determine trends in similar technologies, compare and analyze current risk assessment methods, re-establish existing risk rating determination standards for securing quantification and objectivity with respect to targets of the model for assessing the construction site risk levels through deriving the BIM-based hazard factors, systematize a category by classifying hazard factors of accident cases by item, establish a DB classification system for the risk assessment by matching with a BIM classification system, link a built risk assessment DB (110) and a BIM object to present a quantitative risk space extraction method using the BIM, a risk occurrence intensity calculation algorithm, and a construction site hazard factor visualization method by risk occurrence intensity, present a case-based safety measure derivation process for objective risk level reduction measures after confirming calculated risk levels, and report these safety activities to present a plan to be usable as response materials, verify reliability of a model of the safety measure derivation process and report, and provide the method of establishing the model for assessing the construction site risk levels through deriving the BIM-based hazard factors advanced with the construction site risk assessment models;
CSI profile databases (DBs) (200) based on an actual construction accident case database, which is fundamental standard data obtained by extracting possible hazard factors at construction sites and classifying the hazard factors by work type;
partner servers (300) configured to be servers for construction-related partners that operate the construction sites, and receive technology study trends, various information on the actual construction sites, and the method of establishing the model for assessing the construction site risk levels through deriving the BIM-based hazard factors advanced with the risk assessment models in the construction site risk level assessment server (100); and
participant terminals (400) configured to be terminals of safety managers and experts for transmitting and receiving, at a time when the BIM-based hazard factors advanced with the risk assessment models is derived in the construction site risk level assessment server (100), the model of the safety measure derivation process and report with respect to the model for assessing the construction site risk levels through deriving the BIM-based hazard factors and comprising the safety measure derivation process and report.

5. The system of claim 4, wherein each CSI profile database (DB) is configured to comprise one or more of a DB of the National Disaster Management System of the National Disaster Safety Portal, a DB of the Korea Occupational Safety and Health Agency, a DB of the Facility Management System (FMS), and a DB of the Knowledge Information System of Construction industry (KISCON).
